(19) United States
(12) Patent Application Publication
(10) Pub. No.: US 2008/0210174 A1
(43) Pub. Date: Sep. 4, 2008

(54) Increasing the Protein Concentration of Animal Organisms

(75) Inventors: Jorn Karl, Ludwigshafen (DE); Gerd Diebold, Reutlingen (DE); Markus Rosch, Dienheim (DE); Uwe Oberfrank, Romerberg (DE)

Correspondence Address: CONNOLLY BOVE LODGE & HUTZ, LLP, P O BOX 2207, WILMINGTON, DE, 19899, US

(73) Assignee: BASF AKTIENGESELLSCHAFT, Ludwigshafen (DE)

(21) Appl. No.: 11/792,026

(22) PCT Filed: Nov. 29, 2005
(86) PCT No.: PCT/EP05/12730

§ 371 Date: May 31, 2007

(30) Foreign Application Priority Data
Dec. 1, 2004 (DE) 102004 058 079.0

(51) Int. Cl. A01K 29/00; A23L 1/30; A23L 1/302; A23L 1/304; A23K 1/16

(52) U.S. Cl. 119/710; 426/72; 426/74; 426/648; 119/174

(57) ABSTRACT

The aim of the invention is to identify and provide a substance that influences the protein concentration of animal organisms as well as to provide preparations based on said substance for use in food for animals and humans. Said aim is achieved by using tartronic acid or the derivatives thereof. The invention thus relates to the use of tartronic acid or the derivatives thereof for producing preparations that are suitable for increasing the protein concentration of animal organisms. Also disclosed is the use of preparations containing tartronic acid or the derivatives thereof in animal fodder or food for humans.

The present invention relates to the use of tartronic acid or its derivatives for producing preparations which are suitable for increasing the protein proportion of animal organisms. The invention further relates to the use of tartronic acid or preparations comprising its derivatives in animal feed or human foods.

Further embodiments of the present invention are to be concluded from the claims, the description and the examples. Of course, the abovementioned features of the present subject matter and the features of the present subject matter which are still to be explained hereinafter can be used not only in the combination stated in each case, but also in other combinations, without departing from the scope of the invention.

The first indications of a physiological activity of tartronic acid (2-hydroxymalonic acid) on animal metabolism were found as early as in the 1950s in the context of studies of de novo lipogenesis in rats (Wesson L G., Endocrinology. 1950 October;47(4):302-4.) It was concluded from the results of this study that tartronic acid inhibits the conversion of carbohydrates to fatty acids, if the experimental animals have received a low-fat, but carbohydrate-rich, diet.

The fact that applicability to humans of the physiological effects observed by Wesson in rats is questionable, since, owing to the high glycogen storage capacity, de novo lipogenesis plays virtually no role in humans, was verified by studies in the 1980s (Archeson et al., Am J Clin Nutr. 1988 August;48(2):240-7).

More recent studies have verified, however, that tartronic acid can act as an L-malate analog, and thus inhibits malate-converting enzymes. For instance, a direct inhibitory activity of tartronic acid on the human cytosol and mitochondrial malate enzyme (Chang et al., Arch Biochem Biophys. 1992 Aug. 1;296(2):468-73), and also on the malate enzyme, malate dehydrogenase and the ATP:citrate lyase from Mucor circinelloides was detected (Savitha, World Journal of Microbiology & Biotechnology 16: 513-518, 2000).

Since it is known that ATP:citrate lyase is an important enzyme for fatty acid biosynthesis in microorganisms, and it is also assumed that the malate enzyme participates in the provision of reduction equivalents for fatty acid biosynthesis, the effect of tartronic acid on fatty acid biosynthesis in the fungus Mucor circinelloides was studied by in vivo inhibition studies. These studies showed, however, that the in vivo inhibitory activity of tartronic acid is not sufficient to have a detectable effect on lipid metabolism in this organism.

The fact that, at all events, tartronic acid derivatives esterified with acyl radicals have a physiological effect on human metabolism is disclosed in the application DE 2806804. It is described therein that tartronic acid acyl esters inhibit the activity of human lipases since said esters act as substrate analogs. It is speculated in this document that the food fats consumed, owing to the inhibition of the lipases by the tartronic esters, can no longer be cleaved and thus are excreted undigested.

Further it is to be concluded from the prior art that tartronic acid-containing preparations can be used in humans for treating keratinization disorders of the skin (U.S. Pat. No. 3,988,470) and bone metabolism disorders (Caselli et al., J Bone Mineral Res. 1997 June;12(6):972-81; WO 94/10127).

WO 00/48596 describes solutions or solid mixtures of the antibiotic amoxycillin for treating animals. In these preparation startronic acid can also be added, for example, to improve taste and digestibility.

In the marketing of a product distributed under the name “Slim Beauty Capsule” which comprises a mixture of extracts of highly different plant genera, reference is made to the presence of tartronic acid in this product. In addition, it is noted that tartronic acid, together with other unsaturated fatty acids, has an effect on human metabolism resulting in the reduction of fat accumulation.

According to this publicity, the component Chromax which is additionally present in the “Slim Beauty Capsules” has an activity increasing muscle mass.

Despite increasing nutritional consciousness, there is a steady rise in the number of nutritional disorders in our society.

The most frequent consequence of malnutrition is overweight (obesity), usually a consequence of increased intake and resultant storage of fat.

Nutritional disorders are also playing a greater and greater role with young people. The costs of nutritional disorders in 2001 were approximately 145 billion Deutschmarks.

Two strategies in principle can contribute to overcoming this problem. These are firstly using preventive measures to avoid the development of nutritional disorders, and secondly treating already existing disorders by special diets, including in combination with suitable aid preparations.

Increasing sensitivity of consumers with respect to foods has caused changes in their purchasing behavior.

The altered demand for low-fat meat has changed the breeding aims in animal farming; for instance there has been a change from a high fat proportion to a high lean-meat proportion. Therefore, for example the carcass quality, proportion of muscle meat and thus the proportion of lean meat in carcasses is of great importance with respect to marketing.

Furthermore, there is a great demand for preparations for weight reduction or for preventing weight increase by unwanted fat deposits. In this connection, the demand for “functional food” products has also increased. “Functional food” covers foods which, by adding certain nutrients/ingredients, have been modified in such a way that they are accompanied by specific health uses or advantages, for example supporting the maintenance of an appropriate body weight.

“Functional foods” are therefore comestibles which not only act particularly beneficially on pre-existing health risks, but also intervene actively in the organism and thus have an action similar to drugs.

An object of the present invention was to identify and provide a substance affecting the protein content of animal organisms and also to provide of the preparations based on this substance for use in animal and human nutrition.

It was of particular interest in this case to provide a system which makes it possible to increase the protein proportion of animal organisms and thus to increase the proportion of lean meat of farm animals. Also, an improvement of the “lean body mass” in humans should also be effected, the lean body mass being taken to mean the sum of all mass constituents of an animal organism minus its proportion of fat.

Surprisingly, it has been found that the inventive object has been achieved by the use claimed.

The present invention therefore relates to the use of tartronic acid, its derivatives or its mixtures (hereinafter also summarized as “compounds T”) for producing a preparation suitable for increasing the protein proportion of an animal organism.

A compound T particularly preferred according to the invention is tartronic acid.

The inventively used preparations can also comprise salts of tartronic acid or salts of tartronic acid derivatives. Preferred salts of tartronic acid or of tartronic acid derivatives are ammonium, potassium, sodium, calcium or magnesium salts.

The preparations can comprise not only just a compound T, but also mixtures of different, for example two or more different, compounds T.

Tartronic acid derivatives within the meaning of the present invention comprise all substances of the general formula 1:

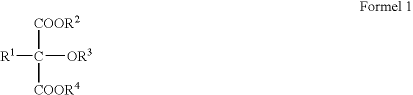

where the substituents and variables independently of one another have the following meaning:
R¹ hydrogen, C₁-C₂₀-alkyl group;
R² hydrogen, C₁-C₂₀ acyl, C₁-C₄ alkyl, C₁-C₄-alkoxyethyl, allyl or p-methoxybenzyl group, an alkali metal or alkaline earth metal, an ammonium or C₁-C₁₀ alkylammonium cation;
R³ hydrogen, C₁-C₂₀ acyl, C₁-C₄ alkyl, C₁-C₄-alkoxyethyl, allyl or p-methoxybenzyl group, an alkali rhetal or alkaline earth metal, an ammonium or C₁-C₁₀ alkylammonium cation;
R⁴ hydrogen, C₁-C₂₀ acyl, C₁-C₄ alkyl, C₁-C₄-alkoxyethyl, allyl or p-methoxybenzyl group, an alkali metal or alkaline earth metal, an ammonium or C₁-C₁₀ alkylammonium cation.

The methods for synthesizing compounds T are known to those skilled in the art and are adequately described in the prior art (see, for example, B. Bak, Justus Liebigs Annalen der Chemie, 537, 286 (1939); P. Chang and S. L. Wu, Chem. Abstr. 52, 14567 (1958); WO 94/10127; Tetrahedron letters, Vol: 39 (18) 1998).

Compounds T, however, can also be synthesized in principle using methods generally known to the specialist field.

In one embodiment, the preparations, in addition to the compounds T, can comprise further constituents. The choice of further constituents will be guided here by the chosen field of use of the preparations. Further constituents within the meaning of the present invention which come into consideration are, for example, the following substances: further organic acids, carotenoids, trace elements, antioxidants, vitamins, enzymes, amino acids, minerals, emulsifiers, stabilizers, preservatives, anticaking agents and/or flavor enhancers.

Examples of representatives of said substance classes which come into consideration can be taken from the respectively valid lists of food additives according to European regulations, for example the currently valid EC Directive 95/2/EC.

Hereinafter, further constituents suitable for producing inventive preparations are listed:

These constituents are added in different amounts to the preparations according to their different properties and as a function of the chosen field of use. The quantitative mixture ratios and also expedient combinations of the substance classes as a function of the chosen field of use are known to those skilled in the art.

Organic acids which are preferably used are formic acid, propionic acid, lactic acid, acetic acid and citric acid, particular preference being given to formic acid, propionic acid or lactic acid.

In the context of the present invention, carotenoids are taken to mean tetraterpenes in which one or two ionone rings are bonded by a carbon chain having 9 double bonds and can be of either plant or animal origin. Carotenoids are also taken to mean the oxygenated xanthophylls. Those which may be mentioned by way of example are: alpha-, beta-, gamma-carotenes, ixin, norbixin, capsanthin, capsorubin, lycopene, beta-apo-8-carotenal, carotinic acid ethyl ester and also the xanthophylls flavoxanthin, lutein, cryptoaxanthin, rubixanthin, violaxanthin, rhodoxanthin and also canthaxanthin.

The inventive preparations can comprise, for example, the following trace elements: chromium, iron, fluorine, iodine, cobalt, copper, manganese, molybdenum, nickel, selenium, vanadium, zinc or tin.

The E numbers listed hereinafter are the designation used in Directive 95/2/EEC for food additives.

Antioxidants which can be used are, for example, ascorbic acid (vitamin C, E 300), sodium L-ascorbate (E 301), calcium L-ascorbate (E 302), ascorbyl palmitate (E 304), butylated hydroxyanisole (E 320), butylated hydroxytoluene (E 321), calcium disodium EDTA (E 385), gallates, for example propyl gallate (E 310), octyl gallate (E 311), dodecyl gallate (lauryl gallate) (E 312), isoascorbic acid (E 315), sodium isoascorbate (E 316), lecithin (E 322), lactic acid (E 270), multiple phosphates, for example diphosphates (E 450), triphosphates (E 451),,polyphosphates (E 452), sulfur dioxide (E 220), sodium sulfite (E 221), sodium bisulfite (E 222), sodium disulfite (E 223), potassium sulfite (E 224), calcium sulfite (E 226), calcium hydrogensulfite (E 227), potassium bisulfite (E 228), selenium, tocopherols (vitamin E, E 306), for example alpha-tocopherol (E 307), gamma-tocopherol (E 308), delta-tocopherol (E 309) and all tocotrienols, tin(II) chloride (E 512), citric acid (E 330), sodium citrate (E 331), carotenoids, vitamin A and also potassium citrate (E 332).

Vitamins which come into consideration are not only fat-soluble vitamins, but also water-soluble vitamins. Examples of fat-soluble vitamins are: vitamin A (retinol), vitamin D (calciferols), vitamin E (tocopherols and tocotrienols), vitamin K (phylloquinones and menaquinones), preference being given to vitamins A and E.

Examples of water-soluble vitamins are: vitamin B1 (thiamine), vitamin B2 (riboflavin), vitamin B5 (pantothenic acid), vitamin B6 (pyridoxin), vitamin B12 (cobalamin), vitamin C (ascorbic acid), vitamin H (biotin), folic acid and niacin, preference being given to the vitamins B2 and C.

The preparations can also comprise enzymes. Those which may be mentioned by way of example are: amylases, proteases and invertases.

Amino acids coming into consideration in the context of this invention are, for example, glutamic acid, L-carnitine, L-glutamine, L-taurine, L-aspartic acid, L-glycine, L-lysine, DL-phenylalanine, L-tryptophan, tyrosine, L-arginine, L-cysteine, L-leucine, L-methionine, L-alanine, L-serine, L-threonine, L-citrulline, L-valine, L-histidine, L-isoleucine, L-ornithine or L-proline.

Particular preference is given to the essential amino acids, for example L-isoleucine, L-leucine, L-lysine, L-methionine, DL-phenylalanine, L-threonine, L-tryptophan and L-valine, very particular preference being given to the amino acids important in animal nutrition L-lysine, DL-methionine or L-threonine.

Minerals in the context of this invention are, for example, sodium, potassium, magnesium, calcium, phosphorus, iron and zinc.

As emulsifiers, use can be made of the following substances, for example: E 420 sorbitol, E 420ii sorbitol syrup, E 421 mannitol, E 422 glycerol, E 431 polyoxyethylene(40) stearate, E 432 polyoxyethylene sorbitan monolaurate/Polysorbate 20, E 433 polyoxyethylene sorbitan monooleate/Polysorbate 80, E 434 polyoxyethylene sorbitan monopalmitate/Polysorbate 40, E 435 polyoxyethylene sorbitan monostearate/Polysorbate 60, E 436 polyoxyethylene sorbitan tristearate/Polysorbate 65, E 440 pectins, E 440i pectin, E 440ii amidated pectin, E 442 ammonium phosphatides, E 444 sucrose acetate isobutyrate, E 445 glycerol esters of root rosin, E 450 diphosphates, E 450i disodium diphosphate, E 450ii trisodium diphosphate, E 450iii tetrasodium diphosphate, E 450iv dipotassium diphosphate, E 450v tetrapotassium diphosphate, E 450vi dicalcium diphosphate, E 450vii calcium dihydrogendiphosphate, E 451 triphosphates, E 451 i pentasodium triphosphate, E 451 ii pentapotassium triphosphate, E 452 polyphosphates, E 452i sodium polyphosphate, E 452ii potassium polyphosphate, E 452iii sodium calcium polyphosphate, E 452iv calcium polyphosphate, E 460 cellulose, E 460i microcrystalline cellulose, E 460ii cellulose powder, E 461 methylcellulose, E 463 hydroxypropylcellulose, E 464 hydroxypropylmethylcellulose, E 465 methylethylcellulose, E 466 carboxymethylcellulose, E 469 enzymatically hydrolyzed carboxymethylcellulose, E 470a sodium salts, potassium salts and calcium salts of fatty acids, E 470b magnesium salts of fatty acids, E 471 mono- and diglycerides of fatty acids, E 472a acetic acid esters of mono- and diglycerides of fatty acids, E 472b lactic acid esters of mono- of diglycerides of fatty acids, E 472c citric acid esters of mono- and diglycerides of fatty acids, E 472d tartaric acid esters of mono- and diglycerides of fatty acids, E 472e mono- and diacetyltartaric acid esters of mono- and diglycerides of fatty acids, E 472f mixed acetic and tartaric acid esters of mono- and diglycerides of fatty acids, E 473 sucrose esters of fatty acids, E 474 sucroglycerides, E 475 polyglycerol esters of fatty acids, E 476 polyglycerol polyricinoleate, E 477 propylene glycol esters of fatty acids, E 479 thermally oxidized soybean oil interacted with mono- and diglycerides of fatty acids, E 481 sodium stearoyl-2-lactylate, E 482 calcium stearoyl-2-lactylate, E 483 stearyl tartrate, E 491 sorbitan monostearate, E 492 sorbitan tristearate, E 493 sorbitan monolaurate, E 494 sorbitan monooleate or E 495 sorbitan monopalmitate.

Stabilizers are substances which maintain the consistency or the composition of foods. Those which may be mentioned by way of example are: ascorbic acid (E 300), carbamide (E 927b), iron(II) lactate (E 585), iron gluconate (E 579), glycerol esters (E 445), lecithin (E 322), metatartaric acid (E 353), pectin (E 440), sucrose acetate isobutyrate (E 444) and tin(II) chloride (E 512).

Preservatives are substances which prolong the shelf life of foods, by protecting them from the harmful effects of microorganisms. Those which may be mentioned by way of example are: E 200 sorbic acid, E 201 sodium sorbate, E 202 potassium sorbate, E 203 calcium sorbate, E 210 benzoic acid, E 211 sodium benzoate, E 212 potassium benzoate, E 213 calcium benzoate, E 214 ethyl p-hydroxybenzoate/PHB ester, E 215 sodium ethyl p-hydroxybenzoate/PHB ethyl ester sodium salt, E 216 propyl p-hydroxybenzoate/PHB propyl ester, E 217 sodium propyl p-hydroxybenzoate/PHB-propyl ester sodium salt, E 218 methyl p-hydroxybenzoate/PHB-methyl ester, E 219 sodium methyl p-hydroxybenzoate/PHB-methyl ester sodium salt, E 220 sulfur dioxide, E 221 sodium sulfite, E 222 sodium hydrogensulfite/sodium bisulfite, E 223 sodium metabisulfite/sodium disulfite, E 224 potassium metabisulfite/potassium sulfite, E 226 calcium sulfite, E 227 calcium hydrogensulfite, E 228 potassium hydrogensulfite/potassium bisulfite, E 230 biphenyl/diphenyl, E 231 orthophenyl phenol, E 232 sodium orthophenyl phenol, E 233 thiabendazole, E 234 nisin, E 235 natamycin, E 239 hexamethylenetetramine, E 242 dimethyl dicarbonate, E 249 potassium nitrite, E 250 sodium nitrite, E 251 sodium nitrate and E 252 potassium nitrate.

Anticaking agents in the context of the present invention are naturally occurring or synthesized substances which increase the flowability of a food by preventing the clumping together and sticking together of the particles. Examples which may be mentioned are: E 530 magnesium oxide, E 535 sodium ferrocyanide, E 536 potassium ferrocyanide, E 541 acidic sodium aluminum phosphate, E 551 silicon dioxide, E 552 calcium silicate, E 553ai magnesium silicate, E 553aii magnesium trisilicate (asbestos free), E 553b talc (asbestos free), E 554 sodium aluminum silicate and E 556 calcium aluminum silicate.

Flavor enhancers in the context of this invention are taken to mean naturally occurring or synthesized substances which are able to round off or enhance the flavor of foods. These also include flavorings. Examples which may be mentioned are: E 620 glutamic acid, E 621 monosodium glutamate, E 622 monopotassium glutamate, E 623 calcium diglutamate, E 624 monoammonium glutamate, E 625 magnesium diglutamate, E 626 guanylic acid, E 627 disodium guanylate, E 628 dipotassium guanylate, E 629 calcium guanylate, E 630 inosinic acid, E 631 disodium inosinate, E 632 dipotassium inosinate, E 633 dicalcium inosinate, E 634 calcium 5-ribonucleotide, E 635 disodium 5-ribonucleotide, E 640 glycine and E 650 zinc acetate.

In one embodiment, the inventively used preparation can comprise aids. Aids are taken according to the invention to mean substances which serve to improve the product properties, such as dusting behavior, flow properties, water absorption capacity and storage stability. Aids can be based on sugars, e.g. lactose or maltose dextrin, based on cereal or legume products, e.g. corn cob meal, wheat bran and soybean meal, based on mineral salts, inter alia salts of calcium, magnesium, sodium or potassium, and also D-pantothenic acid or its salts themselves (D-pantothenic acid salt produced chemically or by fermentation).

In a further embodiment, the inventively used preparations can comprise carriers. Suitable carriers are “inert” carrier materials, that is to say materials which do not display adverse interactions with the components used in the inventive preparation. Obviously, the carrier material must be safe for the respective uses as aid, for example in foods and animal feedstuffs. Suitable carrier materials are not only inorganic carriers but also organic carriers. Examples of suitable carrier materials which may be mentioned are: low-molecular-weight inorganic or organic compounds and also relatively high-molecular-weight organic compounds of natural or synthetic origin. Examples of suitable low-molecular-weight inorganic carriers are salts, such as sodium chloride, calcium carbonate, sodium sulfate and magnesium sulfate, kieselguhr or silicic acid, or silicic acid derivatives, for example silicon dioxides, silicates or silica gels. Examples of suitable organic carriers are, in particular, sugars, for example glucose, fructose, sucrose and also dextrins and starch products. Examples of relatively high-molecular-weight organic carriers which may be mentioned are: starch and cellulose preparations, such as in particular corn starch, corn cob meal, ground rice hulls, wheat semolina bran or cereal flours, for example wheat, rye, barley and oat flour or brans and mixtures thereof.

The inventively used preparations can comprise the further constituents, carriers and aids in mixtures.

The weight fraction of the compounds T in the preparations can vary in wide ranges and is generally orientated according to practical considerations which result from the chosen field of application (for example farm animal husbandry, raising domestic animals or human nutrition).

In one embodiment of the present invention, the preparations suitable for the inventive use can comprise, for example from 5 to 10% by weight, preferably from 10 to 20% by weight, particularly preferably from 20 to 30% by weight, very particularly preferably from 30 to 40% by weight, of compounds T. However, higher weight percentage fractions can also be chosen.

The inventively used preparations are produced in the simplest case by mixing the constituents. Likewise, they can be produced by mixing solutions of the individual components, and if appropriate subsequently removing solvents.

The mixtures of various constituents can be present in any weight ratios to one another.

The simplest form of the mixture is bringing together the constituents in a mixer. Such mixers are known to those skilled in the art, for example from the Ruberg company (vertical twin-shaft mixer (type HM (10-50 000 I)), ring-layer mixer-pelletizer (type RMG), continuous agglomerator dryer (type HMTK), vertical single-shaft mixer (type VM (10-50 000 I)), container mixer (type COM (50-4000 1)). Further mixers can also be obtained from Lödige, Drais, Engelsmann. The mixers can be operated batchwise or continuously. In the batchwise mixer, generally all constituents to be mixed are charged in the desired ratio and then mixed for an adequate time in the region of minutes to hours. The mixing time and the mixing stress are specified so that the constituents are present homogeneously distributed in the mixture. In the case of continuous mixing, the constituents are added continuously, if appropriate after premixing. In the continuous mixer, also, the residence time and mixing stress are to be chosen in such a manner that the constituents are present homogeneously distributed in the mixture. The mixing time is frequently shorter in the continuous case and the stress is higher than in the case of batchwise mixing. The mixing is customarily performed at room temperature, but can also, depending on the substances used, be carried out at higher or lower temperatures.

In a preferred embodiment, the preparations are present in solid form. Depending on the application requirement, the preparations can be powders having a mean particle size of from 10 μm to 5000 μm, preferably having a mean particle size of from 20 μm to 1000 μm.

The resultant particle size distribution of the pulverulent products can be studied in an instrument from Malvern Instruments GmbH, Mastersizer S.

Mixtures of constituents are possible as pure blends, that is to say the substances are mixed together in the desired particle sizes and concentration ratios, if appropriate with addition of further additives, substances also being able to be protected, for example, by a coating if necessary. Furthermore, core-sheath structures can be used, that is to say one constituent is situated on the interior as core and a further constituent as sheath on the outside, or vice versa. Of course, in the case of these structures, further coatings can also be used, if this is necessary. It is also conceivable to encapsulate substances together in a shared matrix of carrier materials or protective colloids. Examples of these are known to those skilled in the art and are described, for example, in R. A. Morten: Fat-Soluble Vitamins, Pergamon Press, 1970, pages 131 to 145.

The powders can be produced by crystallization, precipitation, drying, pelleting or agglomeration methods familiar to those skilled in the art, or other methods for forming solids described in current textbooks.

An animal organism in the meaning of the present invention is taken to mean the organisms taxonomically assigned to the animal kingdom (animalia).

Those which are preferred are the vertebrates (vertebrata) with the orders of the tetrapoda (land vertebrates) and fish (pisces). Particular preference is given to the classes aves (birds) and mammalia (mammals), modern humans (Homo sapiens) being comprised as a particularly preferred mammal.

Very particular preference is given to the families of the True Pigs (Suidae), cattle (Bovinae), pheasants and relatives (Phasianidae), ducks, geese and swans (Anatidae), horses (Equidae), carp family (Cyprinidae) and trout family (Salmonidae).

From these families the most preferred are what are termed domestic animals and farm animals. Domestic animals in the meaning of the present invention are taken to mean animals which are not free-living, are habituated to humans, and are predominantly kept by humans in the domestic residence. Particularly preferred domestic animals are cats and dogs.

Farm animals in the meaning of the present invention are taken to mean animals which are kept by humans for economic purposes.

Particularly preferred farm animals are the genera domestic cattle (Bos taurus), domestic chicken (Gallus gallus domesticus), domestic pig, domestic sheep (Ovis ammon aries) and domesticated types of the gray goose (Anser anser).

The protein proportion of an animal organism is to be taken to mean the total of all protein constituents occurring in an organism and comprises not only soluble (for example enzymes, hormones) but also bound and fibrillar (fibrous) structural proteins such as actin, myosin and tropomyosin which effect the contraction of muscle cells.

Increase in the protein proportion of an animal organism is to be taken to mean the increase in the weight of an animal organism due to the protein proportion of its total weight.

An increase in the protein proportion in the meaning of the present invention is, for example, the increase in the weight of an animal organism due to the protein proportion of its total weight expressed in percent (hereinafter termed PPTW (percentage protein of total weight of an organism)). The increase in PPTW can be calculated as follows, for example:
(i) determination of the difference in PPTW before feeding/intake and after termination of the feed/intake of preparations comprising compounds T, with the preparations having to be administered in such a way that at least 0.05 g of a compound T is administered per day to the animal organism per kg of body weight over a period of at least 7 days;
(ii) comparison of the PPTWs of a) animal organisms to which at least 0.05 g of a compound T is administered per day per kg of body weight over a period of at least 7 days and b) animal organisms which belong to a control group and receive preparations in which only the compounds T have been replaced by a substitute substance, for example an aid.

With these measurements, it must be taken into account that a) a number of animal organisms sufficient for the statistical certainty of the results obtained must be studied and b) all measurements are carried out using the same method. The population sizes and statistical methods necessary for the certainty of statistical data are known to those skilled in the art.

To determine the PPTW, destructive measurement methods can be used. Destructive measurement methods require the slaughter in advance of the animal under test.

In order to be able to detect here an increase in the protein proportion with statistical significance, it is necessary, in the preliminaries to feeding the compounds T, to determine, on the basis of a sufficiently large population of animals, the mean PPTW for these animals under the selected husbandry conditions (housing density, age, feed rate, feed quality, sex, housing temperature etc.) of an animal species. In this case, the individual PPTW of an animal achieved after feeding the compounds T and determined using the same destructive method can be compared with the mean values achieved in advance for animals which have not been fed compounds T and an increase can be established on the basis of a significant deviation from the mean value.

The inventive increase in the protein proportion of an animal can be recognized from the increase in the quotient formed from the percentages by weight of the protein and fat proportion (percentage by weight of protein/percentage by weight of fat, hereinafter termed P/F quotient).

The increase in the P/F quotient in the case of inventive use of the preparations is due not only to the increase in the protein proportion, but also to a coincident decrease in the fat percentage of the total body weight.

The increase in the P/F quotient can be calculated as follows, for example:
(iii) determination of the percentage protein and fat of the total weight of an animal and determination of the formation and comparison of the P/F quotients which are determined from the values before feeding/intake and after completion of the feeding/intake of preparations comprising compounds T, the preparations being fed as described under (i);
(iv) comparison of the P/F quotients of a) test animals and b) control animals as described under (ii).

In these measurements also, the population sizes and statistical methods necessary for the certainty of statistical data and which are known to those skilled in the art must be used.

In addition, destructive methods can also be used to determine the P/F quotient. In order to be able to detect here an increase in the P/F quotient with statistical significance, it is necessary, as described above for determining the PPTW, in the preliminaries of feeding the compounds T to determine the mean P/F quotients of an animal. In this case, the individual or mean P/F quotient of an animal achieved after feeding the compounds T and determined using the same destructive method can be compared with the mean values achieved in advance for animals which have not been fed compounds T and an increase can be established on the basis of a significant deviation from the mean value.

A change in the PPTW and the P/F quotient can also cause a change in the lean body mass.

Successful use of the inventive preparations can therefore be recognized from the increase in the weight of an animal organism due to the protein proportion of its total weight, and also from an increase in the lean flesh or muscle flesh proportion and thus from an increase in the lean body mass.

Methods for determining carcass composition and lean body mass are sufficiently known to those skilled in the art. A distinction can be made here between destructive (measurements performed on the slaughtered animal) and non-destructive methods (measurements performed on the living animal).

Destructive Methods:

Using an optical method, the meat proportion of the undivided carcass can be estimated from a sample (optical grading probe or fiber optic). For these measurements, Fat-O-Meat'er (FOM) instruments can be used. These instruments determine the back fat and muscle thickness by an optical method and estimate the muscle meat proportion of the carcass.

However, specially developed electromagnetic scanners can also be used for estimating carcass composition. For this method, frequently the abbreviation TOBEC (Total Body Electrical Conductivity) is also used. The carcasses are passed in this method through a magnetic field. Since muscle tissue and fat tissue have different conductivities, the energy in the magnetic field is absorbed with different strengths depending on the tissue proportions.

Non-Destructive Methods:

Various methods are available to assess the leanness of the living animal. The most frequently used are the ultrasonic or echo sounding methods.

A further method for estimating the meat proportion not only in the living animal but also in the carcass is bioelectrical impedance.

The method measures the conductivity of the animal body to an alternating current and derives therefrom the body composition.

Further techniques for estimating body composition are X-ray computer tomography (CT) and magnetic resonance spectroscopy (nuclear magnetic resonance, NMR). These measurement techniques, compared with ultrasound instruments, permit much greater degrees of accuracy. For instance it is possible to measure reliably even small changes in the body composition of an individual animal.

The body fat analysis in humans can likewise be carried out using the bioelectrical impedance by means of what are termed body fat analytical balances.

To increase the protein proportion of an animal organism, the inventive preparations can be used in such a way that the administered doses of the compounds T per day make up from 0.01 g to 20 g, preferably from, 0.02 g to 15 g, particularly preferably from 0.03 g to 10 g, very particularly preferably from 0.04 g to 8 g, most preferably from 0.05 g to 6 g, per kg of the weight of the animal organism. However, higher doses of the inventive preparations can also be administered.

The amount of the preparation necessary for the inventive use can also be distributed in a plurality of smaller portions over a day.

For the inventive increase in the protein proportion of an animal organism, it is necessary to administer a compound T in the above described amount for at least a period of 7 days, preferably 14 days, particularly preferably 21 days, very particularly preferably 28 days. However, suitable doses of the inventive compounds T can also be administered over a longer period, for example over the entire lifetime of the animal.

In a further preferred embodiment of the present invention, the compounds T or the preparations containing these, are added to animal feed or human foods.

Particular preference here is given to the inventive use of the preparations in animal feed for farm animals and domestic animals, for example pigs, poultry, calves, and also cats and dogs.

The preparations can be added to the feed here in the form of liquids, powders, premixes, tablets, capsules or suspensions.

In an embodiment, the preparations are administered, independently of the diet, to the animal organisms as liquid, powder, tablet, capsule or suspension, in addition to, or separately from, the standard diet.

The invention further relates to the use of the inventive preparations in human nutrition as therapeutic agent.

Therapeutic agents in the context of this invention are to mean agents which are used not only for reduction in body weight, but also for muscular build-up, for example in popular sport and competitive sports, especially in bodybuilding. This explicitly covers the inventive use of the preparations in dietetic foods or functional food.

In addition, therapeutic agents cause an improvement of the lean body mass in humans. In one embodiment, therapeutic agents are taken to mean those agents which are used not only for prevention, but also for therapeutic treatment, of nutritionally-related, genetically-related obesity, or obesity caused by metabolic disorders. In the therapeutic treatment of obesity, the preparations of the present invention can be formulated in a manner which is generally known to those skilled in the art and is suitable and can be used for the production of pharmaceutical dosage forms with the use of conventional techniques. Such techniques are described, for example, in “Remington's Pharmaceutical Science Handbook”, Mack Publishing Co., New York, USA, 17^{th} edition 1985. Such pharmaceutical dosage forms or food additives can be liquids, powders, premixes, tablets, capsules or suspensions.

It has been found that preparations comprising compounds T have a lasting physiological effect on animal metabolism in such a manner that the protein proportion increases (increase in PPTW). In addition, it has been found that as a consequence of the administration of the inventive preparations, the increase in total body protein content is accompanied by a decrease in total body fat proportion (increase in P/F quotient).

It has been found that the inventive preparations are suitable, in particular, for use in animal nutrition.

### EXAMPLE

### Analytical Methods

1. Determination of Whole Body Crude Protein
1) Method for determining the content of crude protein in mice from the nitrogen content, modified according to Kjeldahl (Kjeldahl, J.: Z. anal. Chem. 22, 366-382. 1883).
2) Principle
   The experimental animals were slaughtered and after removing the gastrointestinal tract, the weight of the animals was determined by weighing. The experimental animals were then shock-frozen in liquid nitrogen and homogenized. The resultant samples were subjected to wet digestion. The acidic digest was made alkaline with sodium hydroxide solution. The ammonia released was removed by distillation and collected in a defined amount of sulfuric acid, the excess of which was titrated with sodium hydroxide solution.
3) Reagents
3.1) Potassium sulfate, analytical grade
3.2) Catalyst: copper(II) oxide, CuO, analytical grade, or crystalline copper sulfate, CuSO₄.5H₂O, analytical grade, or mercury, or mercury oxide, HgO, analytical grade.
3.3) Sulfuric acid; analytical grade, D 1.84
3.4) Pumice stone, granulated, washed with hydrochloric acid and ignited
3.5) Zinc, analytical grade, granulated
3.6) Sulfuric acid, 0.1 N;
3.7) Sulfuric acid, 0.5 N
3.8) Methyl red indicator: 300 mg of methyl red are dissolved in 100 ml of ethanol, from 94 to 96% strength (VN).
3.9) Sodium hydroxide solution, analytical grade, 40% strength (WN)
3.10) Sodium sulfide solution, analytical grade, saturated
3.11) Sodium thiosulfate solution, 8% strength (WN), Na₂S₂O₃.5H₂O, analytical grade
3.12) Sodium hydroxide solution, 0.1 N;
3.13) Sodium hydroxide solution, 0.25 N
4) Apparatus
   Digestion apparatus and distillation apparatus according to Kjeldahl (see above);
5) Digestion
   1 g of the sample was weighed out accurately to 1 mg and placed in the flask of the digestion apparatus. 10 g of potassium sulfate (3.11), a suitable amount of the catalyst (3.2) (from 0.3 to 0.4 g of copper oxide or from 0.9 to 1.2 g of copper sulfate or one drop of mercury or from 0.6 to 0.7 g of mercury oxide), 25 ml of sulfuric acid (3.3) and a few grains of pumice (3.4) were added and the flask contents were mixed. The flask was first heated moderately, then, with shaking from time to time, heated up to carbonization of the substance and disappearance of the foam, and finally intensively up to the uniform boiling of the liquid. Superheating of the flask walls and deposition of organic parts onto the flask walls was avoided. As soon as the solution was clear and colorless (light green when a copper-containing catalyst is used), this was kept boiling for a further 1 hour; thereafter it was allowed to cool.
6) Distillation
   With continuous swirling, from 250 to 356 ml of water were added with care, in which case the sulfates should dissolve completely. The mixture was allowed to cool; then some zinc granules (3.5) were added. Between 10 ml and 25 ml of sulfuric acid (3.6) or (3.7), depending on the expected nitrogen content, and a few drops of methyl red indicator (3.8) were added to the distillation apparatus collection flask. The flask was connected to the condenser of the distillation apparatus and its outermost end was lowered at least 1 cm deep into the liquid of the collection flask. 100 ml of sodium hydroxide solution (3.9) were slowly charged via the stopcock funnel into the distillation flask. When a mercury catalyst is used, in addition, 10 ml of sodium sulfide solution (3.10) or 25 ml of sodium thiosulfate solution (3.11) were added to the distillation flask. The flask is heated in such a manner that, in 30 min, about 150 ml of the liquid had distilled off. After the expiry of this time, the neutral reaction of the overhead distillate was controlled using litmus paper. If the reaction was alkaline, the distillation was continued. It was terminated when the overhead distillate proved to be neutral on the litmus paper. During the distillation operation, the contents of the collection flask were swirled from time to time and its color was observed. When it turned yellowish, immediately an accurately measured amount of sulfuric acid (3.6) or (3.7) was added.
7) Titration
   In the collection flask, the excess sulfuric acid was titrated by means of sodium hydroxide solution (3.12) or (3.13), depending on the normality of the sulfuric acid used, until the color changed to clear yellow.
8) Control of the method
   To establish whether the reagents were nitrogen-free, a blank experiment (distillation and titration) without the sample to be analyzed was performed. To control the accuracy of the method, the analysis (digestion, distillation and titration) was performed using from 1.5 to 2.0 g of acetanilide, analytical grade (melting point: 114° C., % N: 10.36) in the presence of 1 g of nitrogen-free sucrose. 1 g of acetanilide consumed 14.80 ml of sulfuric acid 0.5 N.
9) Calculation of the results
   The amount of sulfuric acid consumed was determined. 1 ml of sulfuric acid 0.1 N is equivalent to 1.4 mg of nitrogen. The amount of nitrogen was multiplied by the factor 6.25. The result was expressed in percentages of the sample.
10) Repeatability
   The difference between two parallel determinations, with the same sample, for contents of less than

| | |
|---|---|
| 20% crude protein shall not exceed | 0.2% absolute, |
| 20% to 40% crude protein | 1.0% relative, |
| more than 40% crude protein | 0.4% absolute. |

Further suitable methods and notes on the analysis for crude protein determination can be taken from the following publications: “Die chemische Untersuchung von Futtermitteln” [Chemical analysis of feedstuffs], Methodenbuch III [Method Book III]; Naumann, K., Neumann-Neudamm, J.; 1982; “Untersuchungen über die Stickstoffbestimmung nach Kjehldahl” [Studies of Kjehldahl nitrogen determination]. Rufeger, H., Z. Tierphysiol., Tierernähr., Futtermittelkunde 22, 49, 1966/67; p. 2. ibid. 189-199; “Zur Rationalisierung der Rohproteinbestimmung” [Rationalization of crude protein determination]. Dickhaut G., Mitteilungs-bI. d. GDCh - Fachgr. Lebensmittelchemie u. gerichtl. Chemie 24, 189-191, 1970)

2. Determination of Total Body Crude Fat
1) The method serves for determining the content of crude fat in mice. Since in the extraction preliminaries, bones and other solid body parts were not removed, the variant described under 2b) was used for determination of total body crude fat of the experimental animals.
2) Principle
   2a) The samples obtained, as described in example 1, were extracted with diethyl ether (3.2). The solvent was distilled off and the ether extract dried and weighed.
   2b) In the case of samples from which the fat could not be completely extracted with diethyl ether without previous hydrolysis, the samples were hydrolyzed with hydrochloric acid at boiling heat. The solution was cooled and filtered. The washed and dried residue was then extracted as described with diethyl ether.
3) Reagents
3.1) Sodium sulfate, analytical grade, anhydrous
3.2) Diethyl ether, anhydrous D 0.720, b.p.: 34.5° C., virtually free from peroxides
3.3) Hydrochloric acid, approximately 3 N
3.4) Filtration aids, for example kieselguhr, Hyflo-supercel
3.5) Carbon tetrachloride, analytical grade
4) Apparatus
4.1) Extraction apparatus according to Soxhlet or equivalent apparatus
4.2) Heating apparatus with temperature controller, explosion-protected
4.3) Vacuum drying cabinet (less than 0.133 bar)
5) Method 2a)
   5 g of the sample were weighed but accurately to 1 mg and mixed with from 2 to 3 g, more if necessary, of sodium sulfate (3.1). The mixture was charged into a fat-free extraction thimble and extracted in an extraction apparatus (4.1) with diethyl ether (3.2) for six hours. When a Soxhiet extraction apparatus is used, the heating must be set so that the solvent drains off at least 15 times per hour. The extract was collected in a dry tared flask provided with some fragments of pumice. After the extraction, the diethyl ether was distilled off, the residue was then dried for one and a half hours in a vacuum drying cabinet (4.3) at 75° C., at below 0.133 bar, and, after cooling, weighed in the desiccator. A second drying of 30 min duration ensures that the weight of fat has remained constant. The weight loss must be less than 1 mg.
   Method 2b)
   2.5 g of the sample were weighed. out accurately to 1 mg and placed in a 400 ml glass beaker or a 300 ml Erlenmeyer flask. Then, 100 ml of hydrochloric acid (3.3) and some pieces of pumice were added. The glass beaker was covered with a watch glass, or the Erlenmeyer flask was fitted with a reflux condenser. The mixture was heated to boiling on a low flame or a heating plate and kept at gentle boiling for one hour. Deposition of the substance to the vessel walls was prevented by occasional swirling. Then, the mixture is cooled and sufficient filtration aid (3.4) was added so that no loss of fat occurred during filtration. Filtration was performed with the use of a moist, fat-free doubled folded paper filter. The residue was washed with clear water until the disappearance of the acidic reaction. Thereafter a test was made as to whether the filtrate contained fat. The presence of fat in the filtrate indicates that, before hydrolysis, the sample needs to be extracted with diethyl ether by method 2a. The doubled filter containing the residue was placed, folded up, on a watch glass and dried in the drying cabinet at from 95 to 98° C. for one and a half hours. Then, filter together with residue was placed in an extraction thimble and extracted with diethyl ether. Then, the procedure as described in 2a was followed.
6) Calculation of the results
   The result was expressed in percentages of the sample.
7) Repeatability
   The difference between two parallel determinations, with the same sample, shall not exceed 0.3% crude fat.
In the case of products of high fat content which are difficult to comminute or are not suitable for removal of a reduced homogeneous sample, the following method was followed: 20 g of the sample were weighed out accurately to 1 mg and mixed with at least 10 g of sodium sulfate (3.1). Then the mixture was extracted with diethyl ether (3.2) according to method 2a. The resultant collected extract was made up to 500 ml with carbon tetrachloride (3.5) and mixed. 50 ml of the solvent were taken off and placed in a small, dry tared flask provided with pumice granules. The solvent was distilled off; then, the mixture was dried and further procedure was followed as in method 2a. The extraction residue in the thimble was freed from the solvent and comminuted to 1 mm. The material was reintroduced into the extraction thimble—no sodium sulfate must be added—and extracted with diethyl ether; then procedure according to method 2a was continued.

The final result was determined taking into account the aliquot in the 1^{st} extraction and expressed in percentages of the sample as follows:

(10a+b)*5

a=ether extract in g after the 1^{st} extraction in the aliquot

b=ether extract in g after the 2^{nd} extraction

### EXAMPLE 3

Composition of the standard feed: mouse/rat (feed can be obtained from Provimi Kliba AG, CH-4303 Kaiseraugst)

| | | Vitamins | | Trace elements |
|---|---|---|---|---|
| Ingredients | Amino acids | (addition/kg of feed) | Major elements | per kg |
| Cereal products and | Arginine 1.10%, | Vitamin A 14000 IE | Calcium 1.05%, | Copper 14 mg |
| energy sources: | Lysine 1.00%, | Vitamin D3 800 IE | Phosphorus | Zinc 60 mg |
| barley, wheat, wheat | Methionine | Vitamin E 80 mg | 0.80%, | Iron 250 mg |
| bran, wheat starch, | 0.39%, | Vitamin K3 4 mg | digestible | Iodine 1 mg/kg |
| corn, soybean oil; | Methionine + | Vitamin B1 20 mg | phosphorus | Manganese |
| plant protein sources: | Cystine 0.75%, | Riboflavin 12 mg | 0.38%, | 60 mg |
| soybean extraction | Tryptophan | Nicotinic acid | Sodium 0.20%, | Selenium 0.3 mg |
| meal, | 0.20%, | 36 mg | Potassium | |
| brewer's yeast, animal | Threonine | Pantothenic acid | 0.78%, | |
| protein sources, | 0.65% | 30 mg | Magnesium | |
| poultry meat meal, | | Folic acid 2 mg | 0.20%, | |
| whey powder; | | Vitamin B6 9 mg | Chlorine 0.36% | |
| mineral sources of | | Vitamin B12 | | |
| major elements: | | 0.05 mg | | |
| carbonate lime, | | Biotin 0.2 mg | | |
| dicalcium phosphate, | | | | |
| salt; | | | | |
| amino acids: | | | | |
| L-lysine, DL- | | | | |
| methionine | | | | |
| vitamin and trace | | | | |
| element premixes | | | | |

### EXAMPLE 1

Increase in the PPTW (Percentage Protein of Total Weight) and increase in the P/F quotient in mice.

In a feeding experiment, 48 mice (type CD-1M (ICR) BR) were divided into three different groups (group 1, 2 and 3) each of 16 animals. The animals were each held in pairs in cages. Each pair was analyzed together, which resulted, per group, in 8 replicates consisting of 2 individuals. At the start of the experiment, the animals were 5 weeks old. The animals were held in pairs in cages with free access to water and feed. The experimental feed used was a standard feed (see example 3).

The standard feed was supplemented with 3% palm fat and 1% cellulose. No tartronic acid was fed to group 1 (control group). In groups 2 and 3, 0.25% and 0.75%, respectively, of the cellulose of the feed was replaced by tartronic acid.

Tartronic acid was administered over a period of 21 days. After this time the animals were slaughtered and the total body fat and total body protein percentages were determined as described above.

| | Tartronic | | | | |
|---|---|---|---|---|---|
| | acid | | | | Mean |
| | [% by | | Number | Mean | total weight |
| | weight | | of animals | feed | gain of the |
| Treatment/ | of the | | per | intake | animals |
| group | feed] | Replicates | replicate | [g/day] | [g/day] |
| 1 | 0 | 8 | 2 | 253.8 | 25.7 |
| 2 | 0.25 | 8 | 2 | 250.4 | 25.2 |
| 3 | 0.75 | 8 | 2 | 246.7 | 24.2 |

| | | Body fat | |
|---|---|---|---|
| | | [% by weight | |
| | Body protein | of body | |
| Treatment | [% by weight of body weight] | weight] | P/F quotient |
| 1 | 62.66 | 23.84 | 2.68 |
| 2 | 65.93 | 20.25 | 3.53 |
| 3 | 66.04 | 20.65 | 3.28 |

There were no significant differences with respect to feed intake and weight gain. Surprisingly, an increase in the PPTW could be observed in the animals fed with tartronic acid, which can also be seen from the increase in the P/F quotient.

1. A method for producing a preparation suitable for increasing the protein proportion of an animal organism comprising producing a preparation which comprises tartronic acid its derivatives or its mixtures (compounds T).

2. The method according to claim 1, wherein the preparation is administered in such a manner that between 0.05 and 6 g of a compound T is fed per day to the animal organism per kg of body weight.

3. The method according to claim 2, wherein the preparation is administered over a period of at least 7 days.

4. The method according to claim 1, wherein the preparation, in addition to a compound T, comprises further organic acids, carotenoids, trace elements, antioxidants, vitamins, enzymes, amino acids, minerals, emulsifiers, stabilizers, preservatives, anticaking agents, flavor enhancers, carriers and/or aids or mixtures of said substances.

5. The method according to claim 4, wherein the preparation is added to animal feed or human foods.

6. The method according to claim 5, wherein the preparation is used in farm animal or domestic animal husbandry.

7. The method according to claim 6, wherein the farm animals and domestic animals are pigs, poultry, calves, cats or dogs.

8. The method according to claim 5, wherein the preparation is used in human nutrition as a therapeutic agent.

9. A method for increasing the protein proportion of an animal organism comprising producing a preparation comprising tartronic acid, its derivatives or its mixtures (compounds T) and administering the preparation to an animal organism, wherein the protein proportion of the animal organism is increased.

10. The method of claim 9, wherein the preparation is administered in such a manner that between 0.05 and 6 g of a compound T per kg of body weight is fed per day to the animal organism.

11. The method of claim 10, wherein the preparation is administered over a period of at least 7 days.

12. The method of claim 9, wherein the preparation, in addition to a compound T, further comprises organic acids, carotenoids, trace elements, antioxidants, vitamins, enzymes, amino acids, minerals, emulsifiers, stabilizers, preservatives, anticaking agents, flavor enhancers, carriers and/or aids or mixtures thereof.

13. The method of claim 12, wherein the preparation is added to animal feed or human foods.

14. The method of claim 13, wherein the preparation is used in farm animal or domestic animal husbandry.

15. The method of claim 14, wherein the farm animal or domestic animal are pigs, poultry, calves, cats or dogs.

16. The method of claim 13, wherein the preparation is used in human nutrition as a therapeutic agent.
